(19) United States
(12) Patent Application Publication
(10) Pub. No.: US 2025/0183686 A1
(43) Pub. Date: Jun. 5, 2025

(54) BATTERY PACK CHARGER

(71) Applicant: BLACK & DECKER INC., New Britain, CT (US)

(72) Inventors: John Kenrick H. Fuerte, Bel Air, MD (US); Brian K. Wohltmann, Shrewsbury, PA (US); Sean Byrne, Towson, MD (US); Cole Macri, Forest Hill, MD (US); Zachary Olmsted, Vienna, VA (US)

(21) Appl. No.: 18/966,000

(22) Filed: Dec. 2, 2024

Related U.S. Application Data
(60) Provisional application No. 63/604,946, filed on Dec. 1, 2023.

(51) Int. Cl. H02J 7/00; H02J 7/02

(52) U.S. Cl. CPC H02J 7/0044; H02J 7/0047; H02J 7/02; H02J 2207/20

(57) ABSTRACT

The present disclosure is directed to a battery pack charger. The battery pack charger may include a housing for holding power conversion components and charging monitoring components. The battery pack charger may be configured to mate with and charge a battery pack. The battery pack may include a housing for holding a plurality of battery cells. The battery pack charger housing may have a width dimension and a length dimension. The battery pack housing may have a width dimension and a length dimension. The battery pack charger housing width dimension and length dimension are generally parallel to the battery pack housing width dimension and length dimension, respectively, when the battery pack charger is mated to the battery pack.

### RELATED APPLICATIONS

This application claims the benefit of priority under 35 U.S.C. § 119(e) to U.S. Provisional Patent Application Ser. No. 63/604,946, filed Dec. 1, 2023, titled “Battery Pack Charger.”

### TECHNICAL FIELD

This application relates to a battery pack charger and a method for manufacturing a battery pack charger. In one example implementation, the charger includes a cup style slide-on interface for coupling with a battery pack.

### BACKGROUND

As illustrated in FIG. 1, an example battery pack charger 10 may include cup style housing 12 including a slide-on interface for mating with a battery pack (not shown). The charger 10 may also include a “brick” power supply components housing 14 (sometimes simply referred to as a “power supply housing”). The power supply housing 14 houses the components for converting AC power supplied from a remote AC power supply, such as a mains line or a generator or solar panels, for example, to DC power for charging the battery pack. This may include changing the voltage level (120V to 18V) and/or changing the current type (alternating current to direct current). The charger 10 may also include an electric cord 16 coupling the power supply housing 14 and the cup housing 12. The charger 10 may also include an electric cord 18 also connected to the power supply housing 14 at one end and having a plug 20 for insertion into a power supply receptacle, for example, an outlet coupled to the mains line. As is clear, the housing 12 including the slide-on interface for coupling the charger 10 to a battery pack and the housing 14 for housing the power supply components are in separate, discrete housings. Such a configuration requires additional wiring and presents a heavy and awkward configuration.

The instant application describes an example battery pack charger in which a cup style, slid-on battery pack charger includes a single housing having the interface for coupling to a battery pack and the power supply components.

### SUMMARY

An aspect of the present invention includes a battery pack charger including at least one charging indicator that is viewable from multiple sides of the charger.

Another aspect of the present invention includes a battery pack charger and battery pack combination. The battery pack charger and battery pack combination may include a battery pack charger and a battery pack. The battery pack charger may have a housing. The battery pack charger housing may define an internal cavity and an external interface for mating with the battery pack in a pack mating direction. The battery pack having a battery pack housing. The battery pack housing may define an internal cavity and an external interface for mating with the battery pack charger in a charger mating direction. The battery pack charger may have an AC power supply cord. The battery pack charger AC power supply cord may be coupled to the battery pack charger housing for providing an AC power signal from an AC power source to the battery pack charger. The battery pack charger may have a plurality of power conversion components. The plurality of power conversion components may be positioned within the battery pack charger housing internal cavity. The plurality of power conversion components may receive the AC power signal and convert the AC power signal to a DC power signal. The battery pack charger housing may have a longitudinal axis. The battery pack charger longitudinal axis may extend parallel to the pack mating direction. The battery pack charger housing may have a length dimension generally parallel to the battery pack charger longitudinal axis and a width dimension generally perpendicular to the battery pack charger longitudinal axis. The battery pack housing may have a length dimension generally parallel to the battery pack charger housing length dimension and a width dimension generally parallel to the battery pack charger housing width dimension when the battery pack charger is mated to the battery pack. The battery pack charger housing length dimension may be less than the battery pack housing length dimension and the battery pack charger housing width dimension may be less than the battery pack housing width dimension.

In another aspect of the battery pack charger and battery pack combination an area defined by the battery pack charger housing width dimension and the battery pack charger housing length dimension may be less than an area defined by the battery pack housing width dimension and the battery pack housing length dimension.

In another aspect of the battery pack charger and battery pack combination, the plurality of power conversion components may include a rectifier.

These and other advantages and features will be apparent from the description and the drawings.

### BRIEF DESCRIPTION OF THE DRAWINGS

FIG. 1 is an isometric view of a first example cup/slide-on battery pack charger.

FIG. 2 is a front elevation view of a second example cup/slide-on battery pack charger.

FIG. 3 is a right side elevation view of the battery pack charger of FIG. 2.

FIG. 4 is a rear elevation view of the battery pack charger of FIG. 2.

FIG. 5 is a left side elevation view of the battery pack charger of FIG. 2.

FIG. 6 is a top plan view of the battery pack charger of FIG. 2.

FIG. 7 is a bottom plan view of the battery pack charger of FIG. 2.

FIG. 8 is a top, front, right isometric view of the battery pack charger of FIG. 2.

FIG. 9 is a top, front, left isometric view of the battery pack charger of FIG. 2.

FIG. 10 is a top, rear, left isometric view of the battery pack charger of FIG. 2.

FIG. 11 is a top, rear, right isometric view of the battery pack charger of FIG. 2.

FIG. 12 is a bottom, front, right isometric view of the battery pack charger of FIG. 2.

FIG. 13 is a bottom, front, left isometric view of the battery pack charger of FIG. 2.

FIG. 14 is a bottom, rear, left isometric view of the battery pack charger of FIG. 2.

FIG. 15 is a bottom, rear, right isometric view of the battery pack charger of FIG. 2.

FIG. 16 is an exploded view of the battery pack charger of FIG. 2.

FIG. 17 is an isometric view of a printed circuit board of the battery pack charger of FIG. 2.

FIG. 18 is an isometric, bottom view of a housing cup of the battery pack charger of FIG. 2.

FIG. 19 is an isometric, top view of the housing cup of FIG. 18.

FIGS. 20A and 20B are front and left elevation views, respectively, of the battery pack charger of FIG. 2 and an example battery pack in a first orientation.

FIGS. 21A and 21B are front and left elevation views, respectively, of the battery pack charger of FIG. 2 and an example battery pack in a second orientation.

FIG. 22 is a front elevation view of the battery pack charger of FIG. 2 and an example battery pack in a third orientation.

FIG. 23 is a front elevation view of the battery pack charger of FIG. 2 and an example battery pack in a fourth orientation.

FIG. 24 is an elevation view of the battery pack charger of FIG. 2 and an example battery pack in a fifth orientation.

FIG. 25 is an elevation view of the battery pack charger and the battery pack of FIG. 24 mounted to a vertical 2×4.

FIG. 26 is a front isometric view of the example battery pack charger and battery pack of FIG. 25 prior to mounting under a table.

FIG. 27 is a front isometric view of the example battery pack charger and battery pack of FIG. 26 mounted under a table.

FIG. 28 is an isometric view of the example battery pack charger of FIG. 2 prior to mounting to a track.

FIG. 29 is an isometric view of the example battery pack charger of FIG. 2 mounted to a track.

FIG. 30 is an isometric view of an example battery pack coupled to the example battery pack charger of FIG. 29.

FIG. 31 is a bottom plan view of the example charger of FIG. 2 illustrating label attached to an AC power cord.

FIG. 32 is an isometric view of the charger of FIG. 31.

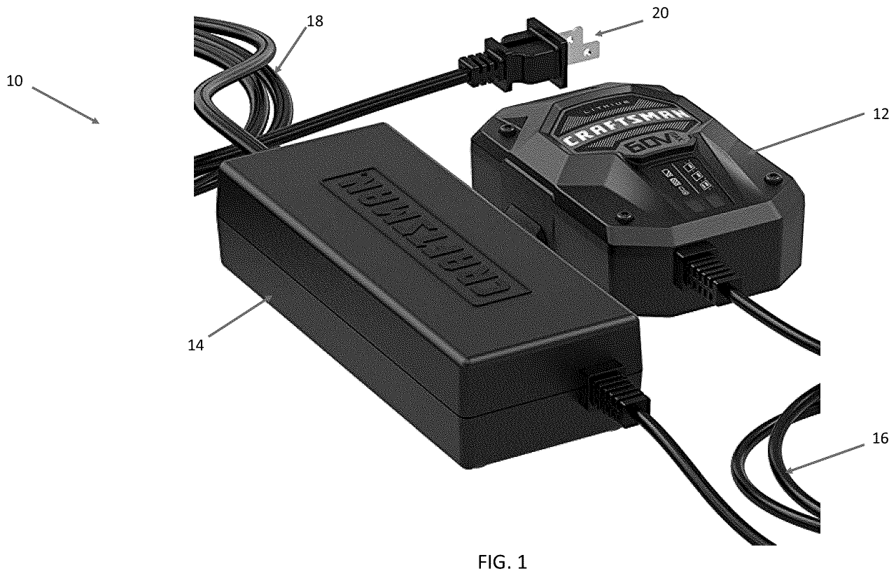

### DETAILED DESCRIPTION

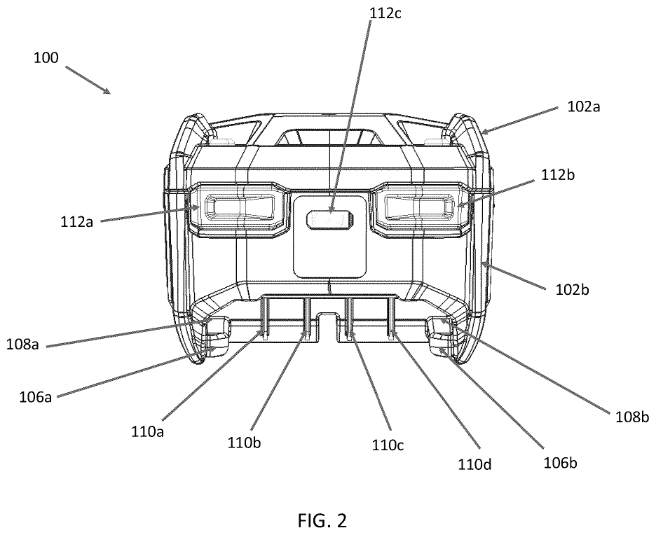

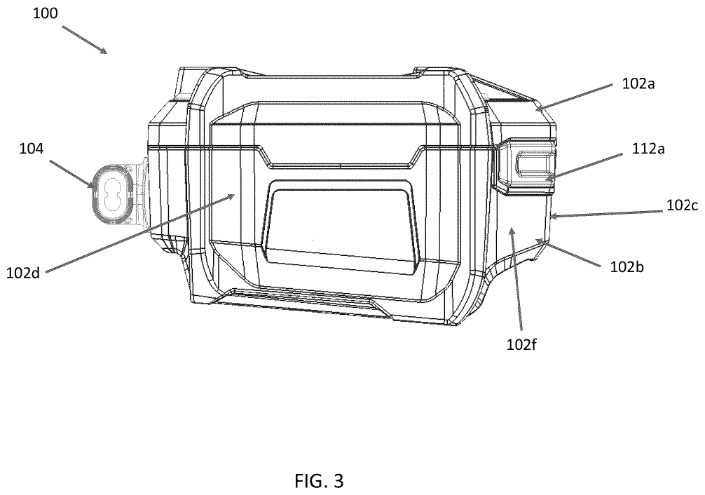

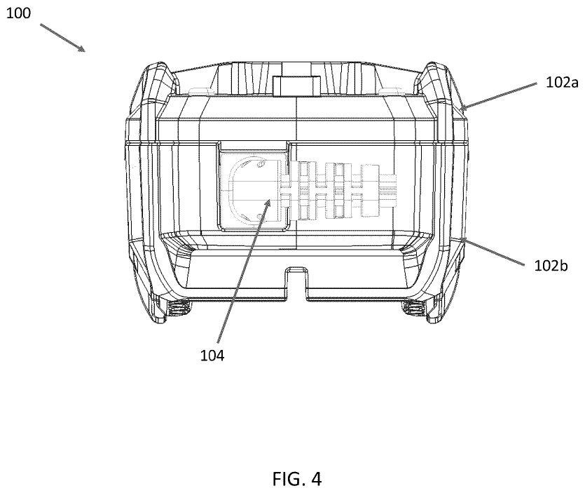

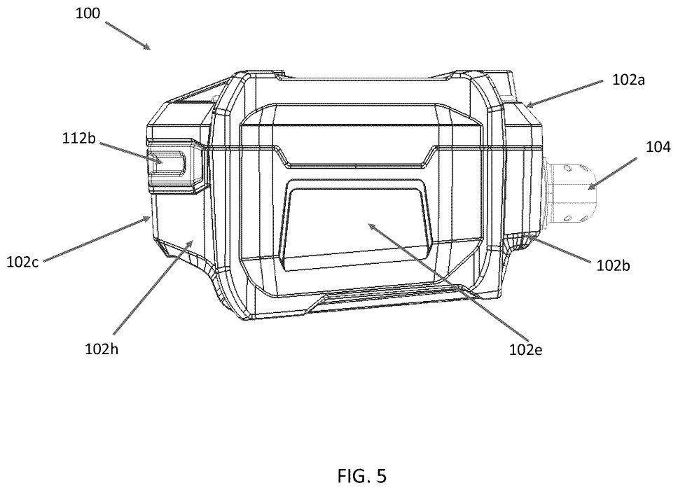

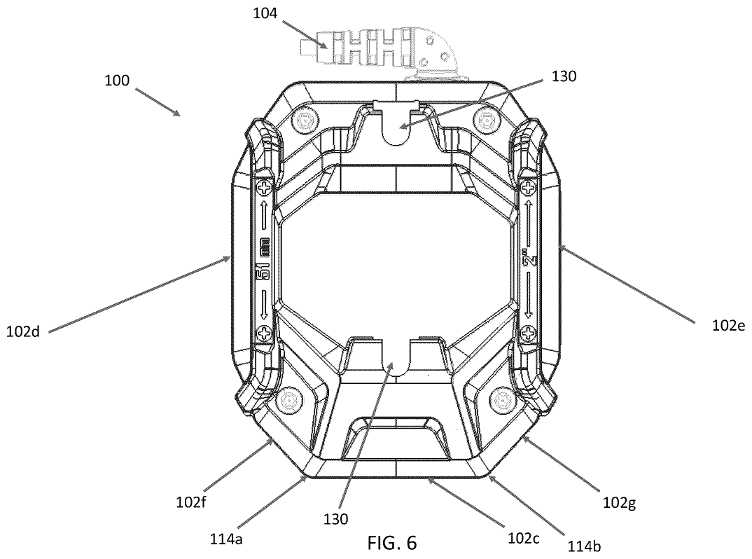

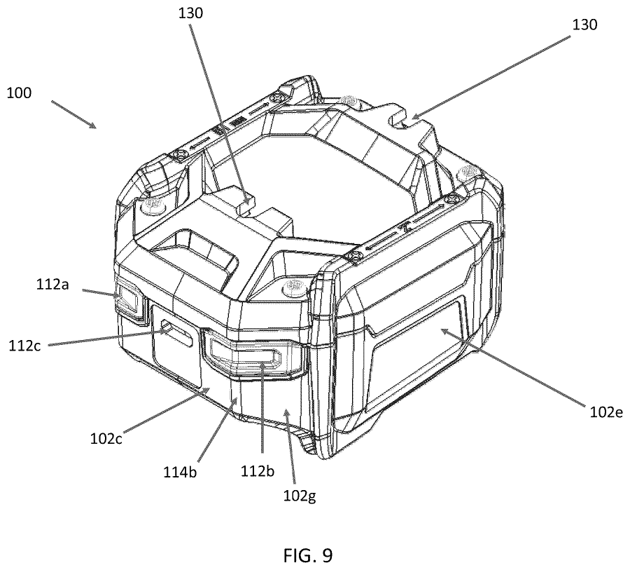

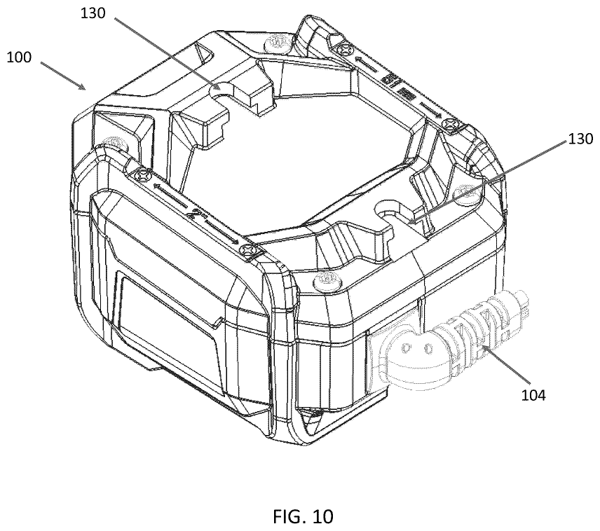

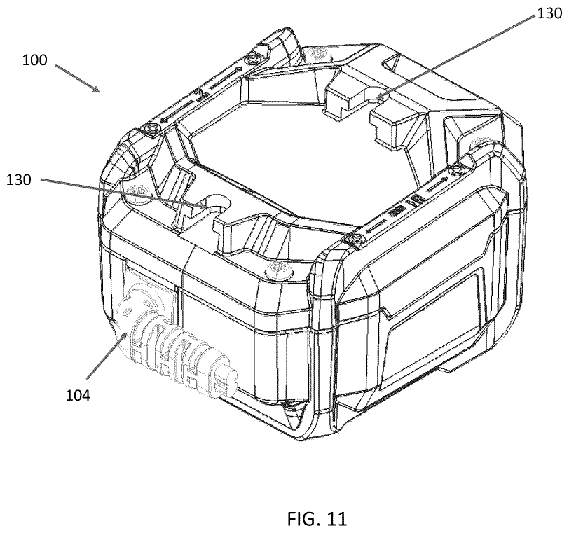

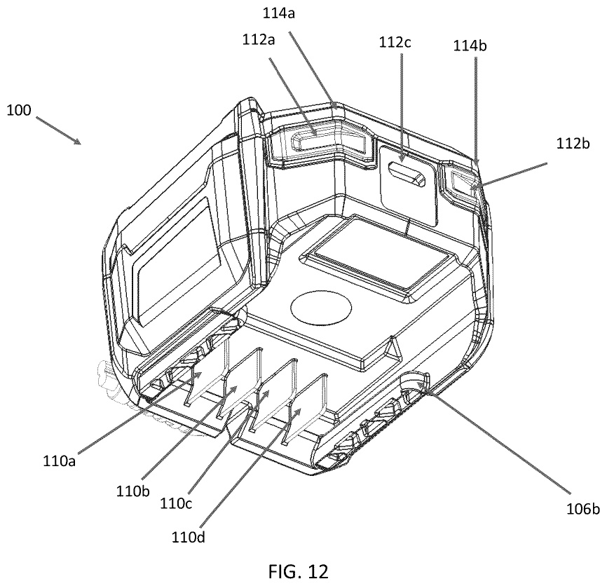

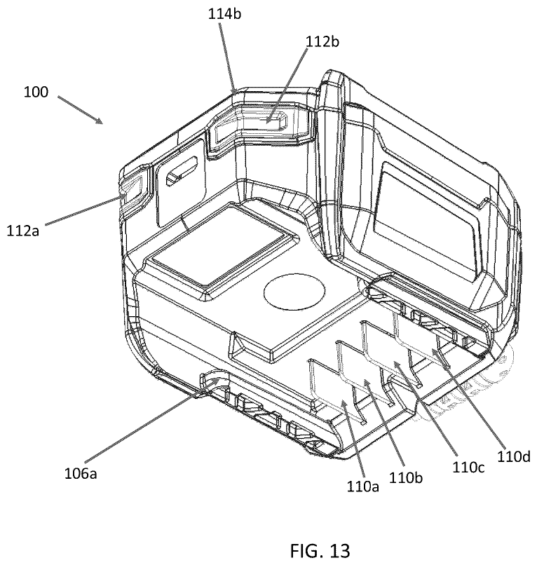

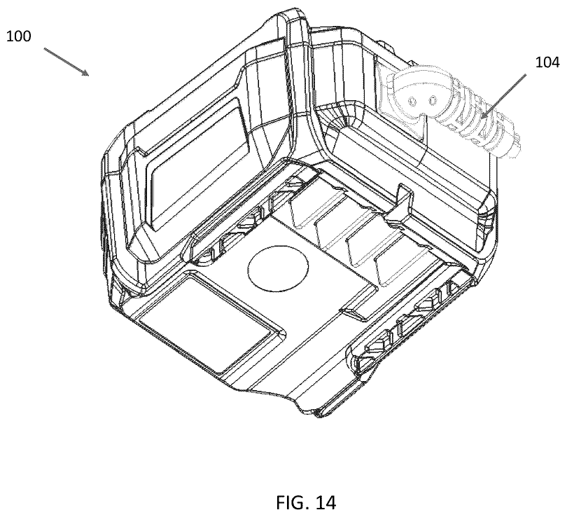

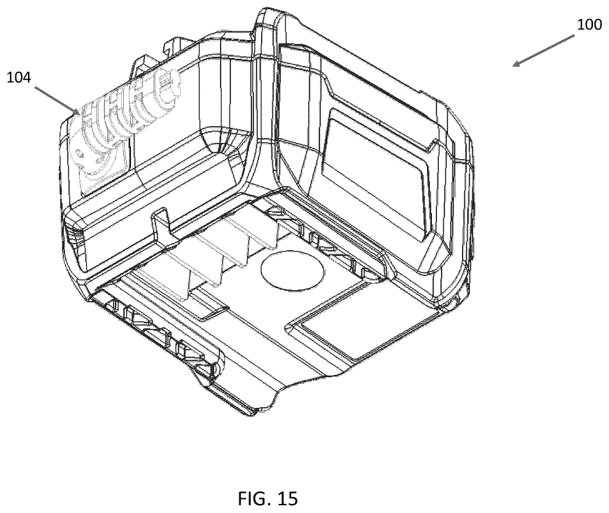

Referring to FIGS. 2-19, there is illustrated an example battery pack charger 100 (sometimes also simply referred to as a charger) of the instant disclosure. As illustrated in FIGS. 2-15, the charger 100 may include a charger housing 102. The charger housing 102 may include a top housing 102a (sometimes referred to as a top cover) and a bottom housing 102b (sometimes referred to as a housing cup). The charger 100 may also include an AC power supply cord 104 (shown only in part in the figures) that may include a plug (not shown) for plugging into an outlet that provides AC power to the charger 100.

The charger 100 may also include an example interface (sometimes referred to as a battery pack interface or a charger portion of a charger-pack interface) for matting with a corresponding example interface of a battery pack (sometimes referred to as a charger interface or a pack portion of the charger-pack interface) to be charged by the charger 100. The example battery pack interface may include a set of rails 106a, 106b (sometimes referred to as charger rails) and grooves 108a, 108b (sometimes referred to as charger grooves) that mate with a corresponding set of rails and grooves of the pack portion of the charger-pack interface. The example charger portion of the charger-pack interface may include a set of charger terminals 110a-d that mate with a corresponding set of battery pack terminals of the pack portion of the charger-pack interface. While not illustrated in the figures, it is well-known in the art for a battery pack to include a set of battery pack terminals for mating with a corresponding set of battery pack charger terminals.

The charger 100 may also include a set of charging indicators 112. The set of charging indicators 112 in the example illustrated charger may include two outer charging indicators 112a and 112b and a third, central charging indicator 112c. As illustrated, for example in FIGS. 2, 3, 5, 8, and 9, each outer charging indicator 112a, 112b presents itself to two sides of the charger housing 102. This enables each outer charging indicator 1121, 112b to be visible to a user from two sides of the charger 100.

The charger housing 102 may include a front side 102c, a right side 102d and a left side 102e wherein the right side 102d and the left side 102e are generally parallel to each other and generally perpendicular to the front side 102c. The charger housing 102 may also include a first connecting side 102f that connects the front side 102c of the charger housing 102 to the right side 102d of the charger housing 102 and a second connecting side 102h that connects the front side 102c of the charger housing 102 to the left side 102e of the charger housing 102. The first connecting side 102f may connect to the front side 102c at an obtuse angle. The first connecting side 102f may connect to the right side 102d at an obtuse angle. The second connecting side 102g may connect to the front side 102c at an obtuse angle. The second connecting side 102g may connect to the left side 102e at an obtuse angle.

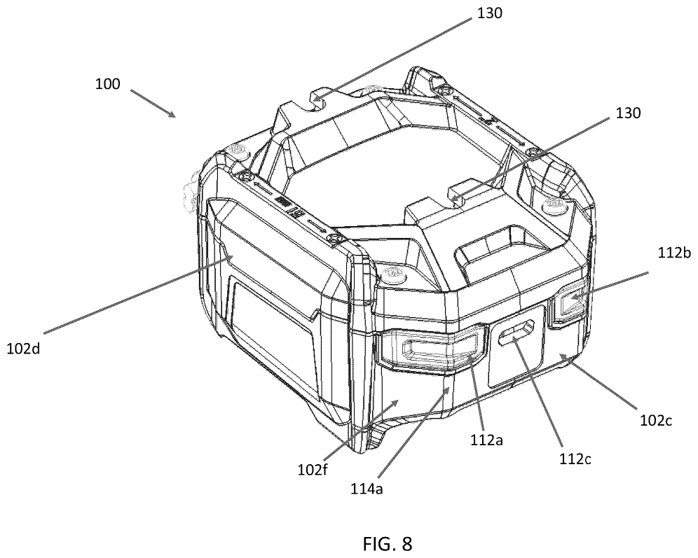

As best illustrated in FIG. 8, the first outer charging indicator 112a includes a portion on the front side 102c of the charger housing 102 and a portion on the first connecting side 102f of the charger housing 102. As best illustrated in FIG. 9, the second charging indicator 112b includes a portion on the front side 102c of the charger housing 102 and a portion on the second connecting side 102g.

In other words, the first charging indicator 112a wraps around a corner 114a connecting the front side 102c of the charger housing 102 and the first connecting side 102f of the charger housing 102 (illustrated in FIGS. 2, 5 and 8) and the second charging indicator 112b wraps around a corner 114b connecting the front side 102c of the charger housing 102 and a second connecting side 102g of the charger housing 102 (illustrated in FIGS. 2, 3, and 9).

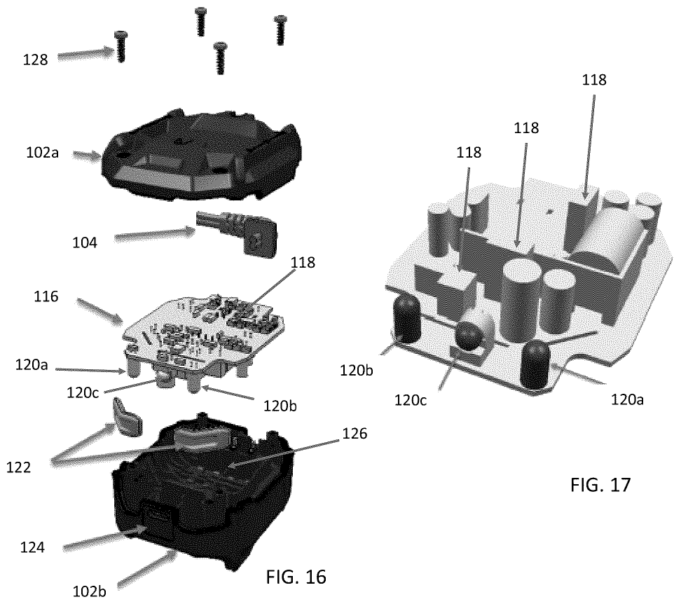

FIG. 16 illustrates an exploded view of the battery pack charger 100. As illustrated, the charger 100 includes the top housing 102a and the bottom housing 102b. The charger 100 ma include a printed circuit board 116. A plurality of power conversion components and charge monitoring components 118 may be mounted to the printed circuit board 116. The AC power signal provided to the charger 100 through the AC power supply cord 104 from the AC power supply. The AC power signal is received by the power conversion components 118. The power conversion components 118 may alter the magnitude of the AC power signal, for example, from 120V AC to 18V AC and may convert the AC power signal from an AC signal to a DC signal. The charging indicators 112 may include an LED 120. The LEDs 120 may be connected to the charge monitoring components 118 and indicate a status of a charging process of the battery pack. The first charging indicator 112a and the second charging indicator 112b may be green LEDs and the third charging indicator 112c may be a red LED. The first charging indicator 112a and the second charging indicator 112b may each include a light lens 120. The third charging indicator 112c may include a transparent label 124.

The top housing 102a and the bottom housing 102b may form an internal cavity 126 when coupled together. The top housing 102a and the bottom housing 102b may be coupled together by an ultrasonic welding process. The top housing 102a and the bottom housing 102b may be coupled together by a plurality of screws 128.

The printed circuit board 116 may be positioned or housed in the internal cavity 126. The printed circuit board 116 may be connected directly to the terminals 110. The printed circuit board 116 may be connected to the terminals 110 by a soldering process. The printed circuit board 116 may be supported by internal features of the top housing 102a and the bottom housing 102b. The light lenses 122 may be held in place by the top housing 102a and the bottom housing 102b. The AC power supply cord 104 may be held in place/retained by the top housing 102a and the bottom housing 102b.

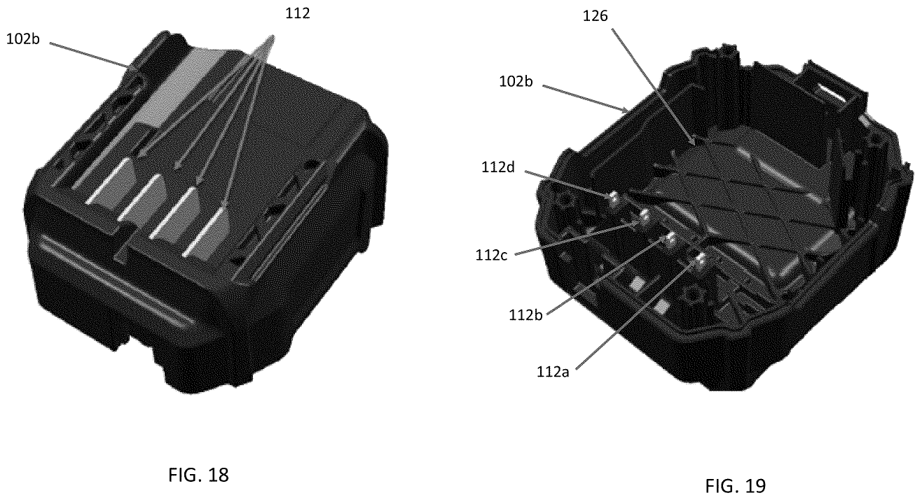

FIG. 18 illustrates an exterior view of the bottom housing 102b including the plurality of charger terminals 112. FIG. 19 illustrates an interior view of the bottom housing 102b including the internal cavity 126. FIG. 19 also illustrates the charger terminals 112a-112d as they extend from the exterior of the bottom housing 102b to the interior of the bottom housing 102b.

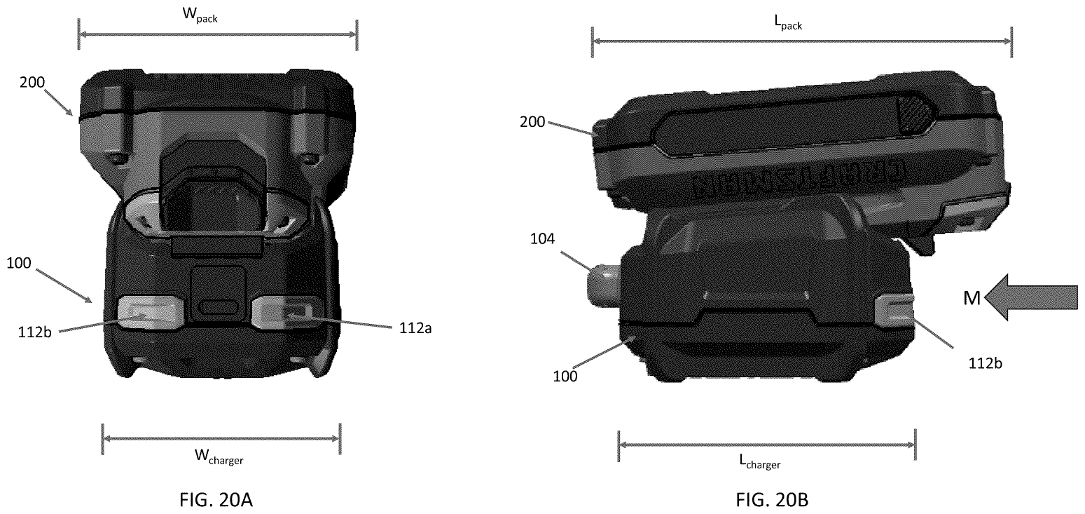

FIGS. 20A and 20B illustrate the example battery pack charger 100 and an example battery pack 200 coupled to the charger 100 in a first orientation. More specifically, the combination of the pack 200 and charger 100 are oriented such that the charger 100 is below the pack 200 and the pack 200 is above the charger 100. In other words, the charger 100 could be resting on a table or a floor and the pack 200 is on top of the charger 100.

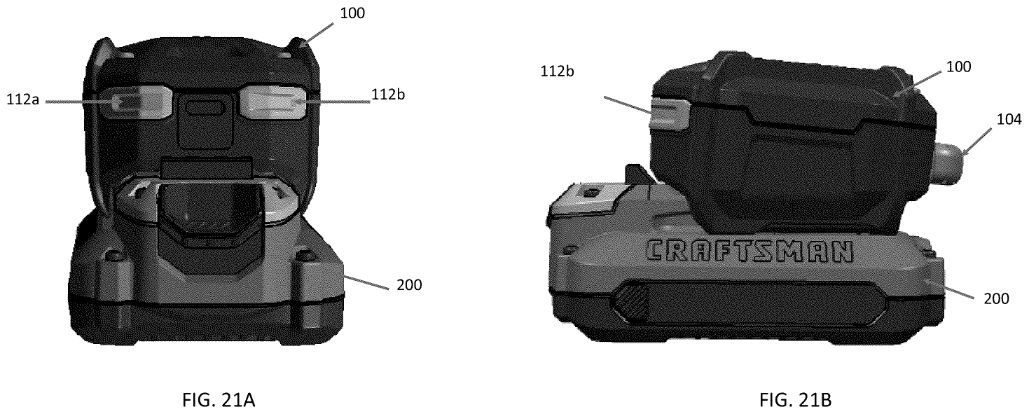

FIGS. 21A and 21B illustrate the example battery pack charger 100 and the example battery pack 200 coupled to the charger 200 in a second orientation. More specifically, the combination of the pack 200 and the charger 100 is oriented such that the pack 200 is below the charger 100 and the charger 100 is above the pack 200. In other words, the pack 200 could be resting on a table or a floor and the charger 100 is on top of the pack 200.

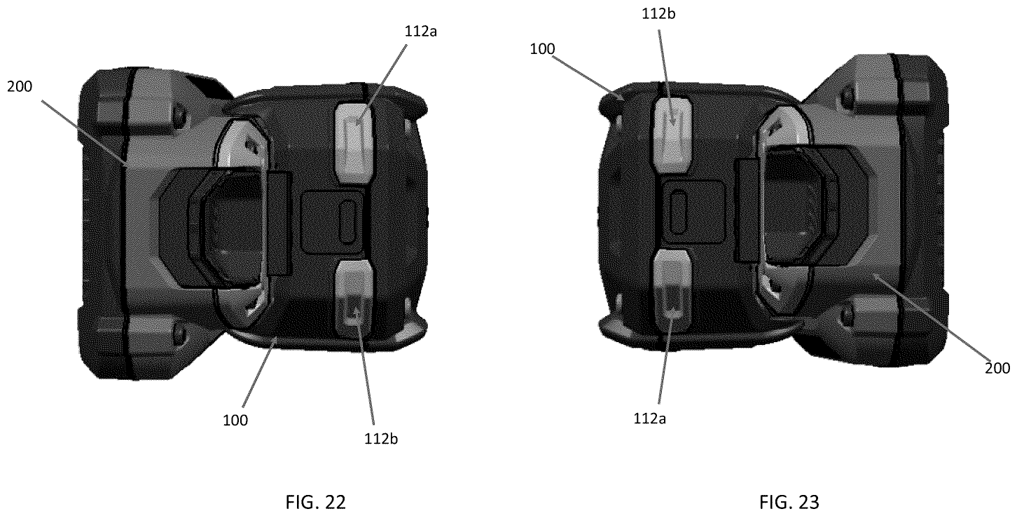

FIGS. 22 and 23 illustrate the example battery pack charger 100 and the example battery pack 200 coupled to the charger 200 in a third orientation and a fourth orientation. More specifically, in FIG. 22, the combination of the pack 200 and the charger 100 is oriented such that the pack 200 and the charger 100 are on a first (left) side of the combination. In other words, both the charger 100 and the pack 200 could be resting on the first side on a table or a floor. In FIG. 23, the combination of the pack 200 and the charger 100 is oriented such that the pack 200 and the charger 100 are on a second (right) side of the combination. In other words, both the charger 100 and the pack 200 could be resting on the second side on a table or a floor.

As clearly illustrated in FIGS. 20A, 20B, 21A, 21B, 22 and 23, as the charging indicators 112a and 112b wrap around the corners 114a, 114b of the charger housing 102, respectively, regardless of the orientation of the charger/pack combination, a user is able to view a charging indicator from both the front (FIG. 20A, FIG. 21A) and from a side (FIG. 20B, FIG. 21B).

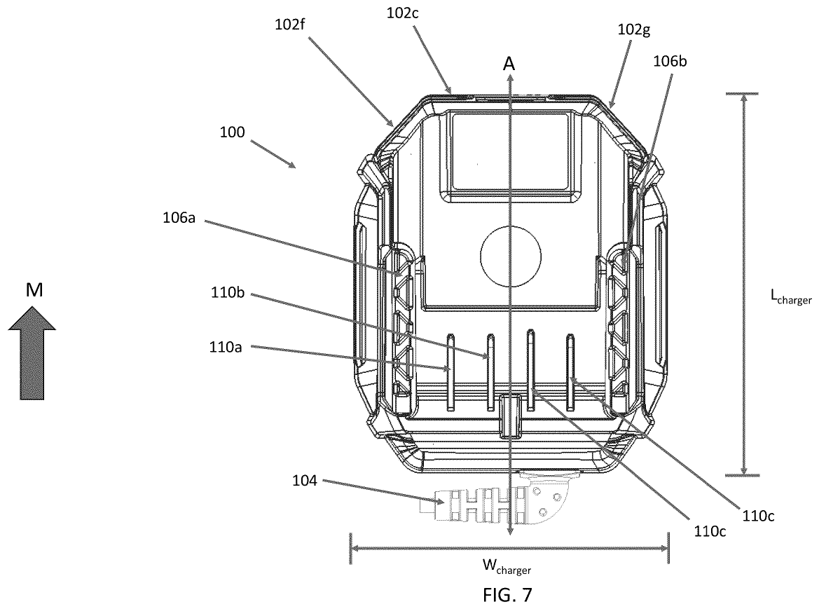

Referring to FIGS. 7, 20A and 20B, the charger 100 has a longitudinal axis A. The charger longitudinal axis A extends parallel to a direction M the battery pack charger 100 moves upon mating with the battery pack 100—referred to as a pack mating direction M. The charger housing 102 may have a length dimension L_{charger} generally parallel to the charger longitudinal axis A and a width dimension W_{charger} generally perpendicular to the charger longitudinal axis A.

Referring to FIGS. 20A and 20B, the battery pack 200 may have a pack housing 202. The pack housing 202 may have a length dimension L_{pack} and a width dimension W_{pack} generally parallel to the charger housing length dimension L_{charger} and the charger housing width dimension W_{charger}, respectively, when the charger 100 and the pack 200 are mated together.

The charger 100 may include the plurality of power conversion components 118. The plurality of power conversion components 118 may positioned within the battery pack charger housing internal cavity 126. The power conversion components 118 may receive the AC power signal through the AC power supply cord 104 from an AC power source. The power conversion components 118 may convert the AC power signal to a DC power signal.

The battery pack housing may have a length dimension L_{pack} generally parallel to the battery pack charger housing length dimension L_{charger} and a width dimension generally parallel to the battery pack charger housing width dimension when the battery pack charger 100 is mated to the battery pack 200.

The battery pack charger housing length dimension L_{charger} may be less than the battery pack housing length dimension L_{pack} and the battery pack charger housing width dimension W_{charger} may be less than the battery pack housing width dimension W_{pack}.

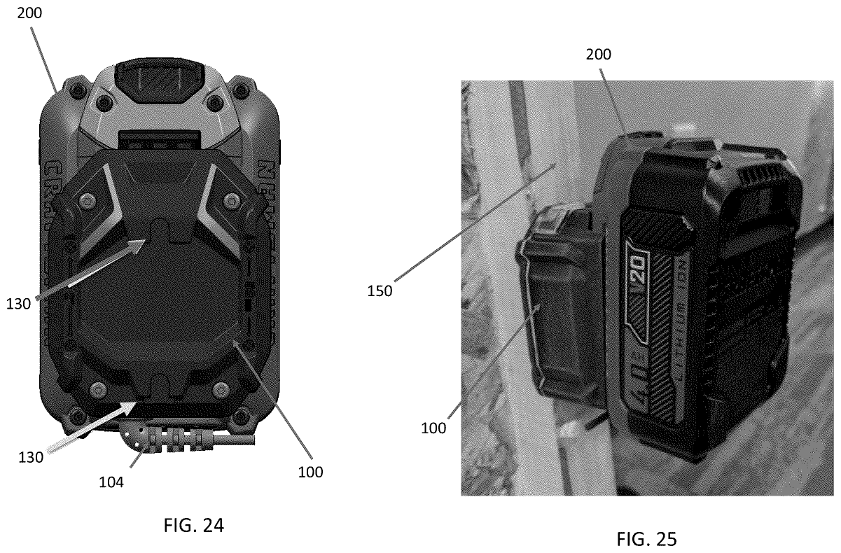

As illustrated in FIG. 24, the charger 100 may include a plurality of slots 130 in the top housing 102a to mount the charger 100. FIG. 24 illustrates the charger 100 and the pack 200 in a vertical orientation. As illustrated in FIG. 25, the charger 100 may be vertically mounted to a vertical stud 150, for example, a 2×4 stud.

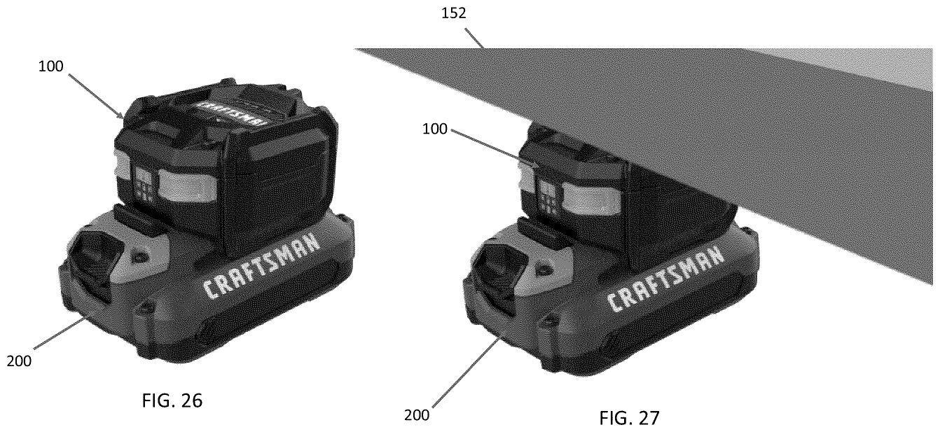

FIG. 26 illustrates the charger 100 and the pack 200 in a horizontal orientation. As illustrated in FIG. 27, the charger 100 may be horizontally mounted to/under a table 152.

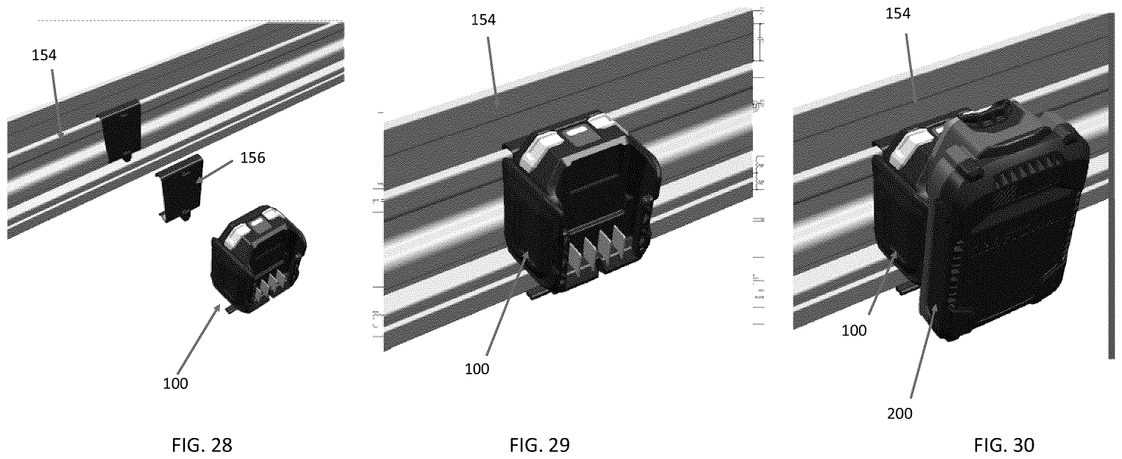

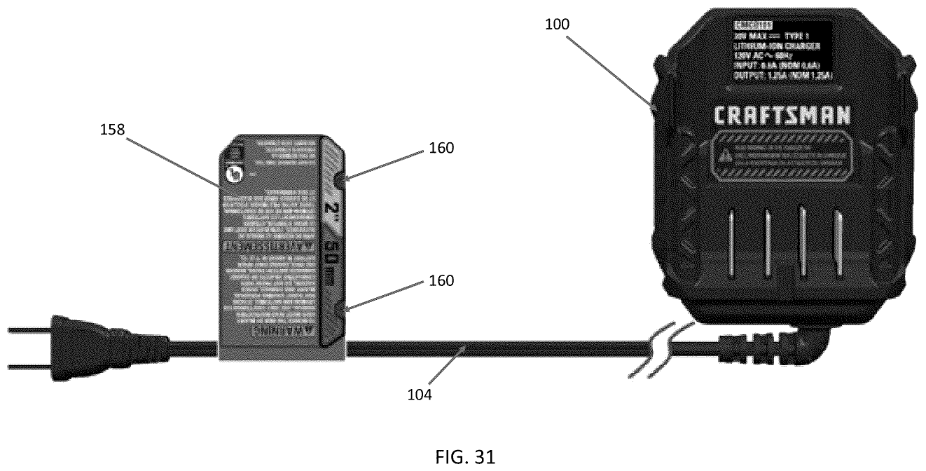

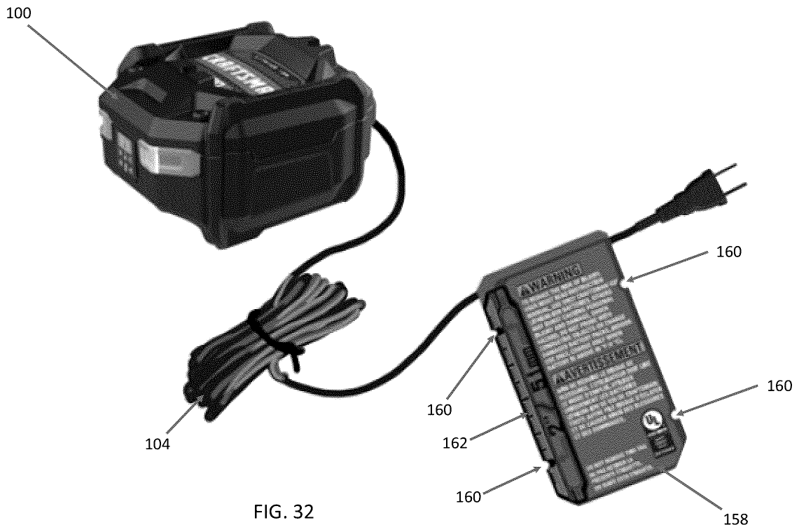

FIG. 28 illustrates a track 152 that may be mounted to a wall. A track mount 156 may be mounted to the track 152. The charger 100 may be coupled to the track mount 156, as illustrated in FIG. 29. Thereafter, the battery pack 200 may be coupled to the charger 100 that is coupled to the track 152.

As noted above, the charger 100 may be mounted to a vertical stud 150 or under a table 152 by placing two screws at appropriately spaced locations such that the slots 130 of the charger 100 may be mounted on the two screws. The appropriate space between the two screws is the same as the space between the two slots 130. The two screws are received in the two slots 130 on the top housing 102a of the charger housing 102. In order to inform the user of the appropriately spaced locations for the two screws and ensure that the two screws are located at the appropriately locations relative to each other, a label 158 may be wrapped around the power cord 104. The label 158 may include a mounting screw template. The mounting screw template may include a pair of screw location indicators 160. The screw location indicators 160 are spaced apart the same amount of space as between the two slots 130 on the top housing 102a of the charger 100. In an alternate example embodiment illustrated in FIG. 32, the label 158 may include a pair of screw location indicators 160 on opposing sides of the label 158. The label 158 may also include a ruler 162. The ruler 162 may include the spacing for the two screws. In the example embodiment, the screws are spaced apart by 2 inches/51 mm.

Numerous modifications may be made to the example implementations described above. These and other implementations are within the scope of this application.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A battery pack charger and battery pack combination, comprising:
a battery pack charger having a housing, the battery pack charger housing defining an internal cavity and an external interface for mating with a battery pack in a pack mating direction, the battery pack having a battery pack housing, the battery pack housing defining an external interface for mating with the battery pack charger in a charger mating direction;
the battery pack charger having an AC power supply cord, the battery pack charger AC power supply cord coupled to the battery pack charger housing for providing an AC power signal from an AC power source to the battery pack charger;
the battery pack charger having a plurality of power conversion components, the plurality of power conversion components positioned within the battery pack charger housing internal cavity and receiving the AC power signal and converting the AC power signal to a DC power signal;
the battery pack charger housing having a longitudinal axis, the battery pack charger longitudinal axis extending parallel to the pack mating direction, the battery pack charger housing having a length dimension generally parallel to the battery pack charger longitudinal axis and a width dimension generally perpendicular to the battery pack charger longitudinal axis,
the battery pack housing having a length dimension generally parallel to the battery pack charger housing length dimension and a width dimension generally parallel to the battery pack charger housing width dimension when the battery pack charger is mated to the battery pack, and
the battery pack charger housing length dimension being less than the battery pack housing length dimension and the battery pack charger housing width dimension being less than the battery pack housing width dimension.

2. The battery pack charger and battery pack combination, as recited in claim 1, wherein an area defined by the battery pack charger housing width dimension and the battery pack charger housing length dimension is less than an area defined by the battery pack housing width dimension and the battery pack housing length dimension.

3. The battery pack charger and battery pack combination, as recited in claim 1, wherein the plurality of power conversion components include a rectifier.

4. A battery pack charger comprising:
a housing, the housing having a front side, a first side and a second side, the first side and the second side being generally opposed and parallel to each other and generally perpendicular to the front side,
a set of charging indicators, a first charging indicator of the set of charging indicators being visible from the front side and the first side and a second charging indicator of the set of charging indicators being visible from the front side and the second side.

5. The battery pack charger, as recited in claim 1, wherein the housing further comprises a first connecting side that connects the front side of the housing to the first side of the housing and a second connecting side that connects the front side of the housing to the second side of the housing.

6. The battery pack charger, as recited in claim 5, wherein the first connecting side connects to the front side at an obtuse angle and to the first side at an obtuse angle and the second connecting side connects to the front side at an obtuse angle and to the second side at an obtuse angle.

7. The battery pack charger, as recited in claim 6, wherein the first charging indicator includes a portion on the front side of the housing and a portion on the first connecting side of the housing and the second charging indicator includes a portion on the front side of the housing and a portion on the second connecting side.

8. The battery pack charger, as recited in claim 6, wherein the first charging indicator wraps around a corner connecting the front side of the housing and the first connecting side of the housing and the second charging indicator wraps around a corner connecting the front side of the housing and the second connecting side of the housing.
